(19) United States
(12) Patent Application Publication
(10) Pub. No.: US 2024/0005477 A1
(43) Pub. Date: Jan. 4, 2024

(54) INDEX SELECTION DEVICE, INFORMATION PROCESSING DEVICE, INFORMATION PROCESSING SYSTEM, INSPECTION DEVICE, INSPECTION SYSTEM, INDEX SELECTION METHOD, AND INDEX SELECTION PROGRAM

(71) Applicant: KONICA MINOLTA, INC., Tokyo (JP)

(72) Inventor: Koki TACHI, Tokyo (JP)

(21) Appl. No.: 18/037,820

(22) PCT Filed: Nov. 4, 2021
(86) PCT No.: PCT/JP2021/040525

§ 371 Date: May 19, 2023

(30) Foreign Application Priority Data
Dec. 16, 2020 (JP) 2020-208476

(51) Int. Cl. G06T 7/00

(52) U.S. Cl. CPC G06T 7/001; G06T 2207/10024; G06T 2207/20081; G06T 2207/30164; G06T 2207/20084

(57) ABSTRACT

Provided are an index selection device, an information processing device, an information processing system, an inspection device, an inspection system, an index selection method, and an index selection program with improved accuracy of defect detection. The index selection device includes a score calculator 230 and an index selector 240. The score calculator 230 calculates abnormality scores of a non-defective product and a defective product by using a plurality of indices based on a plurality of pieces of input data of the non-defective product and the defective product and a plurality of pieces of reference data corresponding to the input data. The index selector 240 selects any one of the plurality of indices according to the abnormality scores of the non-defective product and the defective product.

### TECHNICAL FIELD

The present invention relates to an index selection device, an information processing device, an information processing system, an inspection device, an inspection system, an index selection method, and an index selection program.

### BACKGROUND ART

An inspection device having an image processing function for determining whether an object (workpiece) to be produced is defective or non-defective using an input image obtained by imaging the workpiece in a production line is known. In such an inspection device, a feature amount of an input image is extracted by using an image processing algorithm, and whether a workpiece is defective or non-defective is determined based on a threshold value for separating a non-defective product from a defective product.

In this regard, in order to improve the accuracy of inspection, the following Patent Literature 1 discloses that a rule or a threshold value (inspection logic) which defines a method of determining whether a workpiece is defective or non-defective is dynamically set according to a change in a production environment.

### CITATION LIST

### Patent Literature

Patent Literature 1: JP 2007-327848 A

### SUMMARY OF INVENTION

### Technical Problem

However, in the technology of Patent Literature 1, a feature is extracted by directly performing image processing on an input image, and whether a workpiece is defective or non-defective is determined based on the extracted feature. Therefore, in a case where a workpiece has a defect and a feature of the defect is similar to a structural feature which a non-defective workpiece originally has, it is not possible to distinguish whether an extracted feature is a defect or a structural feature. As a result, there is a problem that the accuracy of defect detection is low.

The present invention has been made in order to solve such a problem, and an object of the present invention is to provide an index selection device, an information processing device, an information processing system, an inspection device, an inspection system, an index selection method, and an index selection program with improved accuracy of defect detection.

### Solution to Problem

The above-described object of the present invention is achieved by the following means.

(1) An index selection device including: a score calculator that calculates abnormality scores of a non-defective product and a defective product by using a plurality of indices based on a plurality of pieces of input data of the non-defective product and the defective product and reference data corresponding to the input data; and an index selector that selects any one of the plurality of indices according to the abnormality scores of the non-defective product and the defective product.

(2) The index selection device according to (1) described above, wherein the abnormality scores are differences between results of calculating the indices using the input data and results of calculating the indices using the reference data for each of the non-defective product and the defective product.

(3) The index selection device according to (1) or (2) described above, wherein the index selector selects an index with which a difference between a distribution of the abnormality score of the non-defective product and a distribution of the abnormality score of the defective product with respect to the plurality of pieces of input data and the reference data is maximized.

(4) The index selection device according to any one of (1) to (3) described above, further including: a data reconstructor that generates reconstructed data as the reference data based on input data of a plurality of non-defective products by a generative model trained using the input data of the plurality of non-defective products.

(5) The index selection device according to any one of (1) to (4) described above, wherein the index selector selects any one of the plurality of indices using a model trained so as to maximize a difference between a distribution of the abnormality score of the non-defective product and a distribution of the abnormality score of the defective product as an objective variable with feature amounts of the plurality of pieces of input data of the non-defective product and the defective product as explanatory variables.

(6) The index selection device according to any one of (1) to (5) described above, wherein the input data is color image data, and the index selector calculates the abnormality scores based on hues and/or saturation as the indices.

(7) An information processing device including: an input data acquirer that acquires input data; and a score calculator that calculates an abnormality score based on the input data acquired by the input data acquirer, reference data corresponding to the input data, and the index selected by the index selection device according to any one of claims 1 to 6.

(8) An inspection device including a determiner that determines a non-defective product or a defective product based on the abnormality score output by the information processing device according to (7) described above.

(9) An information processing system including: the information processing device according to (7) described above; and a display device that displays the abnormality score calculated by the score calculator.

(10) An inspection system including: the inspection device according to (8) described above; and a display device that displays a result of the determination by the determiner.

(11) An index selection method including a step (a) of calculating abnormality scores of a non-defective product and a defective product by using a plurality of indices based on a plurality of pieces of input data of the non-defective product and the defective product and a plurality of pieces of reference data corresponding to the input data; and a step (b) of selecting any one of the plurality of indices according to the abnormality scores of the non-defective product and the defective product.

(12) The index selection method according to (11) described above, wherein the abnormality scores are differences between results of calculating the indices using the input data and results of calculating the indices using the reference data for each of the non-defective product and the defective product.

(13) The index selection method according to (11) or (12) described above, wherein in the step (b), an index with which a difference between a distribution of the abnormality score of the non-defective product and a distribution of the abnormality score of the defective product with respect to the plurality of pieces of input data and the reference data is maximized is selected.

(14) The index selection method according to any one of (11) to (13) described above, further including a step (c) of generating reconstructed data as the reference data based on input data of a plurality of non-defective products by a generative model trained using the input data of the plurality of non-defective products.

(15) The index selection method according to any one of (11) to (14) described above, wherein in the step (b), any one of the plurality of indices is selected by using a model trained so as to maximize a difference between a distribution of the abnormality score of the non-defective product and a distribution of the abnormality score of the defective product as an objective variable with feature amounts of the plurality of pieces of input data of the non-defective product and the defective product as explanatory variables.

(16) The index selection method according to any one of (11) to (15) described above, wherein the input data is color image data, and in the step (b), the abnormality scores based on hues and/or saturation are calculated as the indices.

(17) An index selection program for causing a computer to execute the processing included in the index selection method according to any one of (11) to (16) described above.

### Advantageous Effects of Invention

According to the index selection device of the present invention, since any one of the plurality of indices is selected according to the abnormality scores of the non-defective product and the defective product, it is possible to obtain an index effective for separating the defective product from the non-defective product. Thus, the information processing device calculates the abnormality scores using the index selected by the index selection device. Therefore, a user can check the position or region of an abnormality of an inspection target from an abnormality score map displayed on a display. Furthermore, the inspection device can improve accuracy in determination of the non-defective and defective products to be inspected, based on the abnormality scores calculated by the information processing device.

### BRIEF DESCRIPTION OF DRAWINGS

FIG. 1 is a schematic block diagram illustrating a hardware configuration of an information processing device according to an embodiment.

FIG. 2 is a functional block diagram illustrating main functions of a controller when the information processing device functions as an index selection device.

FIG. 3 is a schematic block diagram illustrating functions of the controller illustrated in FIG. 2.

FIG. 4 is a schematic diagram for describing calculation of an abnormality score by a score calculator illustrated in FIG. 2.

FIG. 5 is a schematic diagram illustrating a result of calculating abnormality scores 1 to N by using index parameters 1 to N.

FIG. 6 is a functional block diagram illustrating main functions of the controller in a case where the information processing device functions as an information processing device.

FIG. 7 is a schematic block diagram illustrating functions of the controller illustrated in FIG. 6.

FIG. 8 is a functional block diagram illustrating functions of a score calculator illustrated in FIG. 7.

FIG. 9 is a functional block diagram illustrating main functions of the controller in a case where the information processing device functions as an inspection device.

FIG. 10 is a flowchart illustrating a processing procedure of an index selection method according to an embodiment.

FIG. 11 is a flowchart illustrating a processing procedure of an inspection method according to an embodiment.

FIG. 12 is a schematic diagram for describing prevention of excessive detection.

### DESCRIPTION OF EMBODIMENTS

Hereinafter, an index selection device, an information processing device, an information processing system, an inspection device, an inspection system, an index selection method, and an index selection program according to embodiments of the present invention will be described with reference to the drawings. In the drawings, the same elements are denoted by the same reference numerals, and redundant description thereof will be omitted.

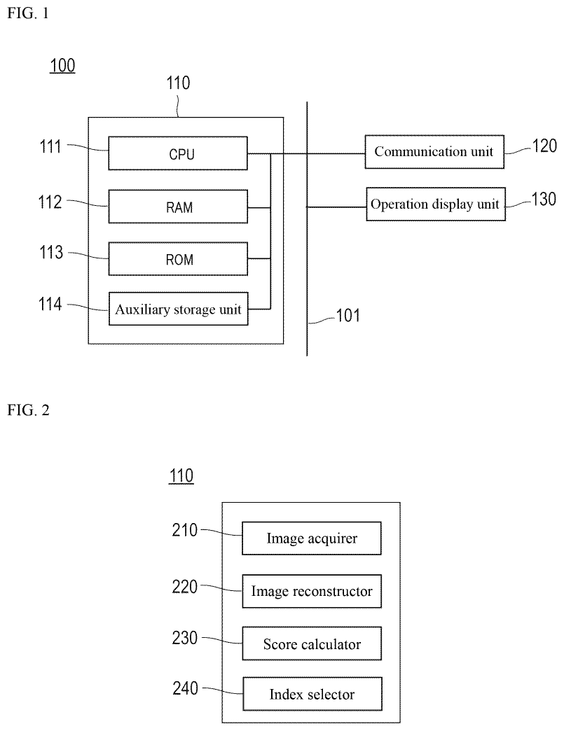

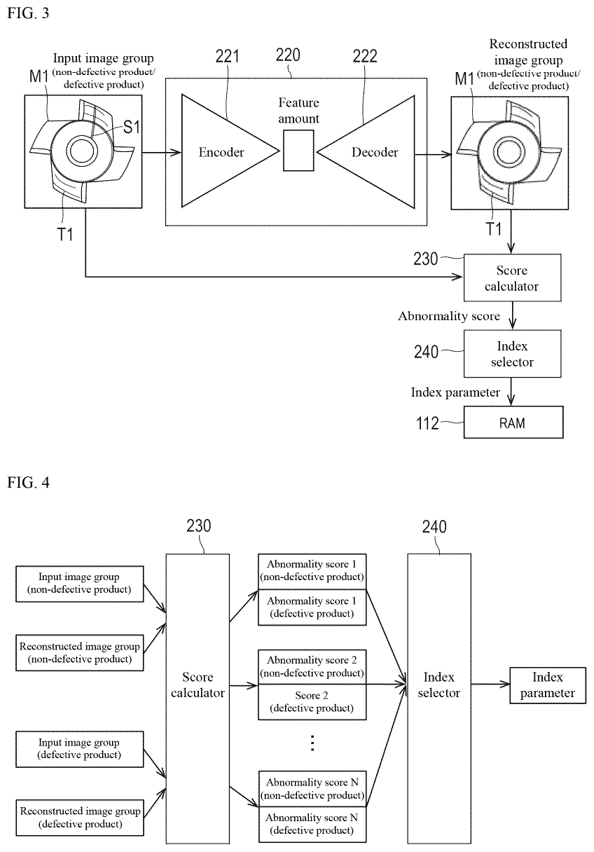

FIG. 1 is a schematic block diagram illustrating a hardware configuration of an information processing device 100 according to an embodiment, and FIG. 2 is a functional block diagram illustrating main functions of a controller 110 in a case where the information processing device 100 functions as an index selection device. Furthermore, FIG. 3 is a schematic block diagram illustrating functions of the controller 110 illustrated in FIG. 2, and FIG. 4 is a schematic diagram for describing calculation of an abnormality score by a score calculator 230 illustrated in FIG. 2. In addition, FIG. 5 is a schematic view illustrating a result of calculating abnormality scores 1 to N by using index parameters 1 to N.

### <Configuration of Index Selection Device>

The information processing device 100 calculates an abnormality score by using a plurality of index parameters (indices) based on a plurality of input images and a plurality of reference images corresponding to the input images. The information processing device 100 functions as an index selection device that selects any one of the plurality of index parameters according to the abnormality score. Each of the input images is labeled with a non-defective product (a normal inspection target) or a defective product (an inspection target including an abnormality such as a defect). By learning (deep learning or machine learning) the index parameters, an index parameter effective for separating a non-defective product from a defective product is selected. The index parameters can be set, for example, as a hue, saturation, and a density, which are color attributes of the input images and a reconstructed image, and a shape, a size, and the like of an object, or a combination thereof. Details of a method of calculating the abnormality score will be described later.

Furthermore, the inspection target is not particularly limited, and examples thereof include a component used for an industrial product. The inspection includes detection of abnormalities such as a fold, a bend, a chip, a flaw, and contamination. The information processing device 100 acquires a plurality of input images (hereinafter, also referred to as “normal input images”) of a non-defective product, learns the images as correct images, and generates a deep learning model (generative model) for generating a reconstructed image from the input images. The reference images may be the reconstructed image of the input images.

As illustrated in FIG. 1, the information processing device 100 includes the controller 110, a communication unit 120, and an operation display unit 130. These components are connected to each other via a bus 101. The information processing device 100 can be, for example, a computer such as a personal computer or a server.

The controller 110 includes a central processing unit (CPU) 111, a random access memory (RAM) 112, a read only memory (ROM) 113, and an auxiliary storage unit 114.

The CPU 111 executes programs such as an operating system (OS), an index selection program, and an inspection program loaded in the RAM 112 to control the operation of the information processing device 100. The index selection program and the inspection program are stored in the ROM 113 or the auxiliary storage unit 114 in advance. Further, the RAM112 stores date temporarily generated by the processing of the CPU 111. The ROM 113 stores a program to be executed by the CPU 111, data and parameters to be used for the execution of the program, and the like. The auxiliary storage unit 114 includes, for example, a hard disk drive (HDD) and a solid state drive (SSD).

As illustrated in FIG. 2, the CPU 111 executes the index selection program, so that the controller 110 functions as an image acquirer 210, an image reconstructor 220, the score calculator 230, and an index selector 240. The image acquirer 210 functions as an input data acquirer and acquires an input image (input data) in cooperation with the communication unit 120.

The image reconstructor 220 functions as a data reconstructor, and generates a reconstructed image (reconstructed data) as reference data based on the input image acquired by the image acquirer 210 by using a generative model trained using an input image of a plurality of non-defective products regarding the same inspection target. More specifically, the image reconstructor 220 extracts a feature amount from the input image using a trained first neural network, and reconstructs (restores) the input image based on the extracted feature amount to generate the reconstructed image.

The first neural network includes a multi-layer convolutional neural network and is trained in advance by supervised learning such that a difference between the reconstructed image and the input image is eliminated or minimized at the time of learning.

The first neural network functions as, for example, a generative model having an encoder-decoder structure. In the present embodiment, for example, an autoencoder (AE) or a variational autoencoder (VAE) can be suitably used as the generative model. Since the AE and the VAE are known techniques, a detailed description thereof will be omitted.

As illustrated in FIG. 3, the image reconstructor 220 has, for example, a VAE including an encoder 221 and a decoder 222 as the generative model. The VAE extracts only an essential element included in the input image by extracting a feature of the input image, and performs reconstruction using the extracted feature amount to generate and output the reconstructed image from which a non-essential element in the input image is excluded. That is, since the VAE performs learning only with a normal input image, the VAE is configured to be able to generate a corresponding feature amount with respect to the normal input image. However, with respect to an input image (hereinafter, also referred to as an “abnormal input image”) of a defective product, that is, an inspection target including an abnormality such as a defect or a flaw, the VAE cannot generate a feature amount corresponding to the abnormality and does not have reproducibility.

In the example illustrated in FIG. 3, the input image includes an image of a member M1 as the inspection target. The member M1 originally has a linear texture T1. In a case where the member M1 is a defective product, the defective product includes, for example, a flaw 51 generated in the middle of a manufacturing process. When the processing of reconstructing the input image is executed, a reconstructed image in which the image of the member M1 is reconstructed is output. The reconstructed image is an image in which only an essential element remains in the image of the member M1 of the input image and in which an unnecessary element is removed from the image of the member M1 of the input image. Since the texture T1 is originally provided (an essential element) in the member M1, the texture T1 is reconfigured. On the other hand, since the flaw Si is abnormal (not an essential element), the flaw Si is not reconstructed.

As described above, since the image reconstructor 220 generates and outputs the reconstructed image in which the non-essential element in the input image is excluded, the difference between the input image and the reconstructed image becomes larger in a case where the product is defective than in a case where the product is non-defective.

In addition, although the case where the reconstructed image of the input image is used as the reference image has been described as an example, a predetermined image regarding the same inspection target may be used as the reference image instead of the reconstructed image. The predetermined image can be, for example, a typical non-defective product image which is not used for the input image and is regarding the same inspection target. However, in a case where there is a positional deviation or a difference in size (magnification) between the input image and the predetermined image, it is necessary to perform correction processing for the positional deviation or the size. On the other hand, in a case where the reconstructed image is used as the reference image, the correction processing is not necessary.

The score calculator 230 calculates abnormality scores by using a plurality of index parameters based on a plurality of input images of a non-defective product and a defective product and a plurality of reconstructed images corresponding to the input images. As illustrated in FIG. 4, for example, based on a plurality of input images each labeled with a non-defective product or a defective product and a plurality of reconstructed images corresponding to these input images, the score calculator 230 calculates abnormality scores 1 to N of the non-defective product and the defective product by using index parameters 1 to N. The abnormality scores can be differences between results of calculating values of the index parameters using the input images and results of calculating values of the index parameters using the reconstructed images for each of the non-defective product and the defective product.

As described above, in the present embodiment, hues and saturation can be used as the index parameters. Thus, for example, even when a detection target has a defect including a fine change in a color that is difficult to detect only with a luminance value, it is possible to a region in which the defect is present.

FIG. 5 illustrates a distribution of the values of the abnormality scores for the non-defective product and the defective product in an orthogonal coordinate system in which the horizontal axis and the vertical axis indicate the normalized abnormality score and the number of samples (input images) used for the selection of an index parameter, respectively. The abnormality scores based on the index parameters 1 to N correspond to abnormality scores 1 to N, respectively. Non-defective samples are mostly distributed in regions where the normalized abnormality scores are relatively small, and defective samples are mostly distributed in regions where the normalized abnormality scores are relatively large. Data of the abnormality scores 1 to N is saved in the auxiliary storage unit 114.

The index selector 240 selects any one of the index parameters 1 to N according to the abnormality scores 1 to N of the non-defective product and the defective product. In the example illustrated in FIG. 5, in the abnormality scores 1 and 2, an abnormality score of the non-defective product (a hatched portion in FIG. 5) and an abnormality score of the defective product (a gray portion in FIG. 5) overlap each other, and it is difficult to separate the both. On the other hand, in the abnormality score N, since there is little overlap between an abnormality score of the non-defective product and an abnormality score of the defective product, the both are easily separated. Therefore, the index selector 240 selects the index parameter N with which a difference between a distribution of an abnormality score of the non-defective product and a distribution of an abnormality score of the defective product is maximized. In the present embodiment, the index parameter is selected by performing deep learning.

More specifically, the index selector 240 has, for example, a multilayer convolutional neural network (second neural network), and performs deep learning (or machine learning) on the index parameters for a plurality of input images of the non-defective product and the defective product regarding the same inspection target. By inputting a plurality of input images of the same inspection target, abnormality scores are accumulated for each pair of an input image and a reference image, and the learning of the index parameters is deepened.

In the present embodiment, the index selector 240 trains the second neural network so as to maximize a difference (distance) between a distribution of an abnormality score of the non-defective product and a distribution of an abnormality score of the defective product (that is, a distance between a statistic of the abnormality score of the non-defective product and a statistic of the abnormality score of the defective product) as an objective variable with feature amounts of a plurality of input images of the non-defective product and the defective product as explanatory variables, and generates a trained model. The statistics may be, for example, histograms.

In addition, the index parameters may be learned such that the probability of erroneously detecting the non-defective product is reduced.

In addition, the case where the index parameters are subjected to deep learning has been exemplified, but the present invention is not limited to such a case, and the index parameter may be selected such that the difference (distance) is maximized by performing regression analysis after setting the explanatory variables and the objective variable as in the case of deep learning.

Then, the index selector 240 uses the trained model to select any one (the index parameter N in the example of FIG. 5) of the plurality of index parameters for one inspection target.

The communication unit 120 is an interface circuit (for example, a LAN card) for communicating with an external device via a network.

The operation display unit 130 includes an input unit and an output unit. The input unit includes, for example, a keyboard, a mouse, and the like, and is used for a user to perform various instructions (inputs) such as character input and various settings using the keyboard, the mouse, and the like. The output unit includes a display (display device) and displays an input image and the like.

Furthermore, although not illustrated in the drawings, the inspection target is imaged by an imaging device such as a camera, for example. The imaging device transmits image data of the imaged inspection target to the information processing device 100. The information processing device 100 acquires the image data as the input images. The image of the inspection target captured in advance by the imaging device may be stored in a storage device outside the information processing device 100, and the information processing device 100 may sequentially acquire a predetermined number of images of the inspection target stored in the storage device as the input images.

For example, when the inspection target is a component of an industrial product, the imaging device is installed in an inspection process, photographs a photographing range including the inspection target, and outputs data of an image including the inspection target. The imaging device outputs, for example, data of a black-and-white image or a color image having predetermined pixels (for example, 128 pixels×128 pixels) and including the inspection target.

### <Configurations of Information Processing Device and Information Processing System>

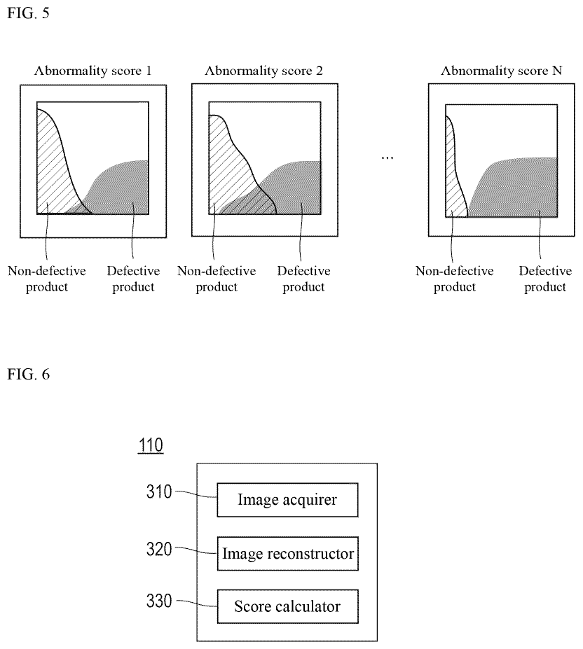

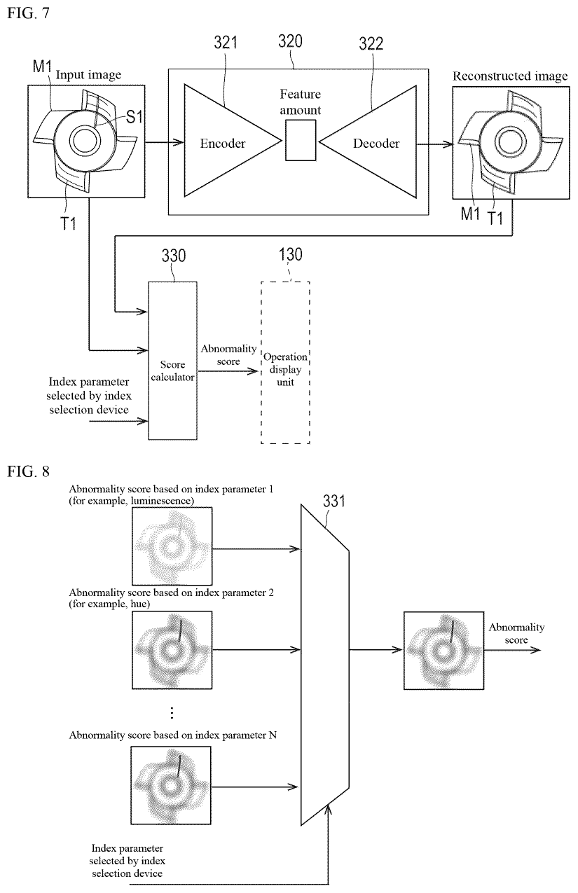

FIG. 6 is a functional block diagram illustrating main functions of the controller 110 in a case where the information processing device 100 functions as an information processing device. FIG. 7 is a schematic block diagram illustrating functions of the controller 110 illustrated in FIG. 6, and FIG. 8 is a functional block diagram illustrating functions of a score calculator 330 illustrated in FIG. 7.

As illustrated in FIG. 6, when the CPU 111 executes the inspection program, the controller 110 functions as an image acquirer 310, an image reconstructor 320, and the score calculator 330.

The image acquirer 310 functions as an input data acquirer and acquires an input image (input data) in cooperation with the communication unit 120.

As illustrated in FIG. 7, the image reconstructor 320 functions as a data reconstructor, and generates a reconstructed image (reconstructed data) as reference data based on the input image acquired by the image acquirer 310 using a generative model trained using an input image of a plurality of non-defective products. More specifically, the image reconstructor 320 extracts a feature amount from the input image using the trained first neural network, and reconstructs (restores) the input image based on the extracted feature amount to generate the reconstructed image.

Note that as described later, whether the product is a non-defective product or a defective product is determined in a determiner 340, but in a case where an input image includes noise, there is a possibility that an abnormality score is not appropriately calculated due to the noise. To cope with this, it is possible to adopt a configuration in which filter processing is performed on the input image and the reconstructed image in advance. A filter may be a noise removal filter (e.g., a low-pass filter, a high-pass filter, or a band-pass filter). With such a configuration, an effect of noise on an abnormality score is reduced, and it is possible to prevent or suppress the degradation of the determination performance (separation performance) for non-defective and defective products due to noise.

The score calculator 330 calculates an abnormality score between the input image acquired by the image acquirer 310 and the reconstructed image reconstructed by the image reconstructor 320. As illustrated in FIG. 8, the score calculator 330 includes an arithmetic processing unit 331. The arithmetic processing unit 331 calculates an abnormality score as an output of the score calculator 330 using at least any one of the abnormality scores of the index parameters 1 to N.

The score calculator 330 calculates a value of an index parameter used by the arithmetic processing unit 331 among the index parameters 1 to N, and calculates an abnormality score based on the value of the index parameter. For example, when only the abnormality score of the index parameter 1 (luminance in the drawing) is set to be used, the score calculator 330 calculates the value of the index parameter 1 and the abnormality score thereof for the input image and the reconstructed image. In this case, the arithmetic processing unit 331 calculates the abnormality score as the output of the score calculator 330 based on only the abnormality score of the index parameter 1. The abnormality score of the index parameter 1 can be, for example, a difference between a luminance value of the input image and a luminance value of the reconstructed image.

Furthermore, the same applies to a case where any one of the index parameters 2 to N is used alone. The abnormality score of the index parameter 2 can be, for example, a difference between a result of calculating the index parameter 2 using the input image and a result of calculating the index parameter 2 using the reconstructed image. Furthermore, the same applies to a method of calculating the abnormality scores of the other index parameters.

The arithmetic processing unit 331 can set use/non-use of each of the abnormality scores of the index parameters 1 to N based on the index parameter selected by the index selection device and stored in the RAM 212.

Furthermore, for example, when the abnormality score of the index parameter 2 (hue in the drawing) is set to be used in addition to the abnormality score of the index parameter 1, the arithmetic processing unit 331 calculates an abnormality score as an output of the score calculator 330 based on the abnormality scores of both indices that are the abnormality score of the index parameter 1 and the abnormality score of the index parameter 2. For example, the abnormality score of the score calculator 330 can be calculated by weighting the abnormality score of the index parameter 1 and the abnormality score of the index parameter 2 with predetermined coefficients and summing the scores.

The operation display unit 130 displays the abnormality score (abnormality score map) calculated by the score calculator 330 on the display. Accordingly, the user can check the position or region of the abnormality of the inspection target from the abnormality score map displayed on the display. The controller 110 and the operation display unit 130 constitute an information processing system.

### <Configurations of Inspection Device and Inspection System>

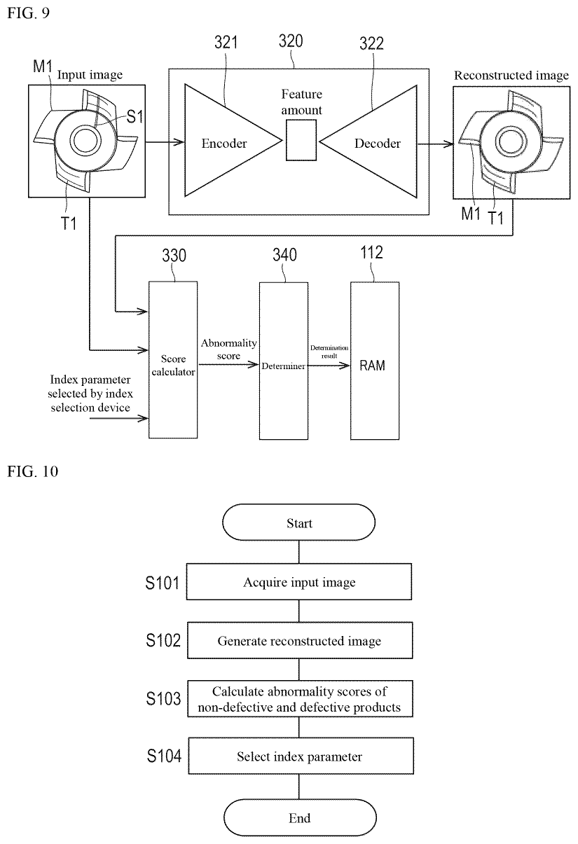

FIG. 9 is a functional block diagram illustrating main functions of the controller in a case where the information processing device functions as an inspection device. The controller 110 includes the determiner 340 in addition to the image acquirer 310, the image reconstructor 320, and the score calculator 330.

The determiner 340 determines whether the inspection target is a non-defective product or a defective product based on the abnormality score calculated by the score calculator 330. For example, in a case where only the abnormality score of the index parameter 1 is set to be used in the score calculator 330, the determiner 340 can determine that the inspection target is a non-defective product in a case where the maximum value of the abnormality score (abnormality score map) of luminescence is equal to or less than a predetermined first threshold value set in advance, and can determine that the inspection target is a defective product in a case where the maximum value exceeds the first threshold value. Therefore, in the abnormality score map, a region in which the first threshold value is exceeded is estimated to be a defective region such as a flaw in the inspection target. The first threshold value can be determined experimentally by a user, for example, based on an abnormality score map calculated for an image of a plurality of inspection targets including a non-defective product and a defective product.

In addition, the determiner 340 can determine whether a product is a non-defective product or a defective product using only an abnormality score of luminance. However, for example, in a case where it is difficult to detect a defective region with an abnormality score of luminance, it is possible to determine whether the product is a non-defective product or a defective product using an abnormality score calculated based on the abnormality score of luminance of the index parameter 1 and the abnormality score of a hue of the index parameter 2. Alternatively, the determiner 340 can also determine whether the product is a non-defective product or a defective product by using only the abnormality score of the index parameter 2.

The determiner 340 sets a second threshold value for separating a defective product from a non-defective product for each index parameter in advance based on distributions of abnormality scores of the non-defective and defective products calculated by the score calculator 230 of the index selection device. The determiner 340 can determine that the inspection target is a non-defective product when the maximum value of abnormality scores (abnormality score map) calculated based on the index parameters by the score calculator 330 is equal to or less than the second threshold value, and can determine that the inspection target is a defective product when the maximum value exceeds the second threshold value. Therefore, in the abnormality score map, a region in which the second threshold value is exceeded is estimated to be a defective region such as a flaw in the inspection target. Furthermore, when the abnormality score to be output by the score calculator 330 is calculated based on the abnormality scores of the plurality of index parameters, the second threshold value can be experimentally determined by a user based on, for example, the abnormality scores calculated for images of a plurality of inspection targets including a non-defective product and a defective product. The determination result is stored in the RAM112. The determination result can be displayed on the display of the operation display unit 130. The information processing device 100 constitutes an inspection system.

### <Index Selection Method>

FIG. 10 is a flowchart illustrating a process procedure of an index selection method according to the present embodiment. The processing of the flowchart of FIG. 10 is implemented by the CPU 111 executing the index selection program.

First, an input image is acquired (step S101). For example, the image acquirer 210 acquires a plurality of input images of an inspection target from an imaging device or a storage device outside the information processing device 100. Each of these input images is labeled with a non-defective product or a defective product in advance. The image acquirer 210 transmits the plurality of input images to the image reconstructor 220 and the score calculator 230.

Next, a reconstructed image is generated (step S102). The image reconstructor 220 generates a plurality of reconstructed images corresponding to the plurality of input images by a generative model based on the plurality of input images acquired by the image acquirer 210.

Next, abnormality scores of non-defective and defective products are calculated (step S103). The score calculator 230 calculates abnormality scores 1 to N by using the index parameters 1 to N based on the plurality of input images of the non-defective and defective products and the plurality of reconstructed images corresponding to the input images.

Next, an index parameter is selected (step S104). The index selector 240 selects any one of the index parameters 1 to N according to the abnormality scores 1 to N of the non-defective product and the defective product. More specifically, the index selector 240 learns, for example, the index parameters for the plurality of input images of the non-defective product and the defective product, and selects, from the index parameters 1 to N, an index parameter with which a difference between a distribution of an abnormality score of the non-defective product and a distribution of an abnormality score of the defective product is maximized.

### <Inspection Method>

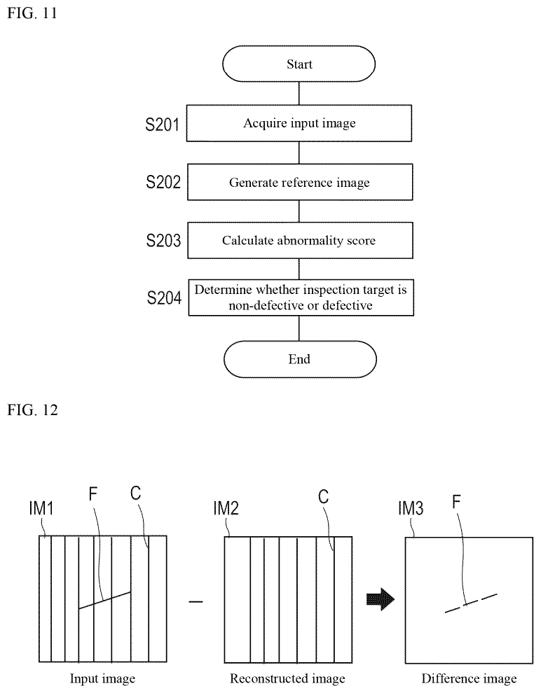

FIG. 11 is a flowchart illustrating a process procedure of an inspection method according to the present embodiment. The processing of the flowchart of FIG. 11 is implemented by the CPU 111 executing the inspection program. FIG. 12 is a schematic diagram for describing prevention of excessive detection.

First, as illustrated in FIG. 9, an input image is acquired (step S201). For example, the image acquirer 310 acquires an input image of an inspection target from an imaging device or a storage device outside the information processing device 100. The input image is an image of the (unknown) inspection target for which a non-defective product or a defective product has not been determined. The image acquirer 310 transmits the input image to the image reconstructor 320 and the score calculator 330.

Next, a reconstructed image is generated (step S202). The image reconstructor 320 generates a reconstructed image corresponding to the input image by the generative model based on the input image acquired by the image acquirer 310.

Next, an abnormality score is calculated (step S203). The score calculator 330 calculates an abnormality score of luminance based on the input image and the reconstructed image corresponding to the input image. In addition, the score calculator 330 calculates an abnormality score by using the index parameter selected in step S104 of the index selection method based on the input image, the reconstructed image corresponding to the input image, and the index parameter selected in step S104 of the index selection method. An index parameter is selected for each inspection target.

Next, it is determined whether the inspection target is non-defective or defective (step S204). The determiner 340 determines whether the inspection target is a non-defective product or a defective product based on the abnormality score of the luminance calculated by the score calculator 330 and the abnormality score based on the index parameter. In the example illustrated in FIG. 7, since the second threshold value is exceeded in the region corresponding to the flaw Si in the abnormality score map based on the index parameter, it is determined that the inspection target is a defective product.

Further, in the present embodiment, defect detection can be performed on a difference between a luminance value of the input image and a luminance value of the reconstructed image. As illustrated in FIG. 10, for example, it is assumed that an input image IM1 includes a linear defect F added in the manufacturing process in addition to a linear feature C originally included in the non-defective product. In a reconstructed image IM2 corresponding to the input image IM1, the feature C of the input image IM1 is reconstructed, but the defect F is not reconstructed. Therefore, a difference image IM3 is generated by subtracting a luminance value of the reconstructed image IM2 from a luminance value of the input image IM1, and the defect F remains in the difference image IM3.

Since the difference image IM3 does not include the feature C of the non-defective product, the linear defect F can be detected by, for example, a linear defect detection algorithm or the like. In contrast, in the related art in which image processing is directly performed on the input image IM1, even in a case where the linear defect detection algorithm is used, the input image IM1 includes the feature C of the non-defective product and the linear defect F. Therefore, there is a possibility that not only the defect F but also the feature C may be detected as defects.

As described above, in the present embodiment, when defect detection is performed, a detection algorithm can be used for the difference between the luminance value of the input image and the luminance value of the reconstructed image. Therefore, even when a feature of the non-defective product and a feature of the defect match each other or are similar to each other, it is possible to more effectively prevent or suppress excessive detection of the non-defective product as compared with the related art.

According to the index selection device, the information processing device, and the inspection device according to the present embodiment described above, the following effects can be obtained.

Since the index selection device selects any one of the plurality of indices according to abnormality scores of the non-defective product and the defective product, an index effective for separation of the defective product from the defective product is obtained. Accordingly, since the information processing device calculates abnormality scores using an index selected by the index selection device, the user can check the position and region of an abnormality to be inspected from the abnormality score map displayed on the display. Furthermore, the inspection device can improve accuracy in determination of the non-defective and defective products to be inspected, based on the abnormality scores calculated by the information processing device. In addition, it is possible to improve robustness and the accuracy of defect detection for various inspection targets and defect types.

The main configurations of the index selection device, the information processing device, the information processing system, the inspection device, the inspection system, the index selection method, and the index selection program have been described in the description of the features of the above-described embodiment, and the present invention is not limited to the above-described configurations and can be variously modified within the scope of the claims. Furthermore, a configuration included in a general inspection device or the like is not excluded.

For example, some of the steps in the flowcharts described above may be omitted, and other steps may be added. Furthermore, some of the steps may be executed at the same time, and one step may be divided into a plurality of steps and executed.

In addition, although the aforementioned embodiments describe the case where the information processing device 100 also serves as the index selection device, the information processing device, and the inspection device, the present invention is not limited to such a case, and the index selection device, the information processing device, and the inspection device may be implemented on separate hardware.

Furthermore, the means and methods for performing the various kinds of processing in the above-described devices can be implemented by either a dedicated hardware circuit or a programmed computer. For example, the programs may be provided by a computer-readable recording medium such as a USB memory or a digital versatile disc (DVD)-ROM, or may be provided online via a network such as the Internet. In this case, the programs recorded in the computer-readable recording medium are normally transferred to and stored in a storage unit such as a hard disk. Furthermore, the programs may be provided as standalone application software, or may be incorporated, as a function, into software of a device such as the index selection device or the information processing device.

This application is based on Japanese Application No. 2020-208476 filed on Dec. 16, 2020, the disclosure of which is incorporated herein by reference in its entirety.

### REFERENCE SIGNS LIST

100 information processing device
110 controller
111 CPU
112 RAM
113 ROM
114 auxiliary storage unit
120 communication unit
130 operation display unit
210 image acquirer
220 image reconstructor
221 encoder
222 decoder
230 score calculator
240 index selector
310 image acquirer
320 image reconstructor
321 encoder
322 decoder
330 score calculator
331 arithmetic processing unit
340 determiner

What is claimed is:

1. An index selection device comprising:
a hardware processor that
calculates abnormality scores of a non-defective product and a defective product by using a plurality of indices based on a plurality of pieces of input data of the non-defective product and the defective product and a plurality of pieces of reference data corresponding to the input data, and
selects any one of the plurality of indices according to the abnormality scores of the non-defective product and the defective product.

2. The index selection device according to claim 1, wherein the abnormality scores are differences between results of calculating the indices using the input data and results of calculating the indices using the reference data for each of the non-defective product and the defective product.

3. The index selection device according to claim 1, wherein the hardware processor selects an index with which a difference between a distribution of the abnormality score of the non-defective product and a distribution of the abnormality score of the defective product with respect to the plurality of pieces of input data and the plurality of pieces of reference data is maximized.

4. The index selection device according to claim 1, further comprising a hardware processor that generates reconstructed data as the reference data based on input data of a plurality of non-defective products by a generative model trained using the input data of the plurality of non-defective products.

5. The index selection device according to claim 1, wherein the hardware processor selects any one of the plurality of indices using a model trained so as to maximize a difference between a distribution of the abnormality score of the non-defective product and a distribution of the abnormality score of the defective product as an objective variable with feature amounts of the plurality of pieces of input data of the non-defective product and the defective product as explanatory variables.

6. The index selection device according to claim 1, wherein the input data is color image data, and the hardware processor calculates the abnormality scores based on hues and/or saturation as the indices.

7. An information processing device comprising:
an hardware processor that
acquires input data, and
calculates an abnormality score based on the input data acquired by the hardware processor, reference data corresponding to the input data, and the index selected by the index selection device according to claim 1.

8. An inspection device comprising a hardware processor that determines a non-defective product or a defective product based on the abnormality score output by the information processing device according to claim 7.

9. An information processing system comprising:
the information processing device according to claim 7; and
a display device that displays the abnormality score calculated by the hardware processor.

10. An inspection system comprising:
the inspection device according to claim 8; and
a display device that displays a result of the determination by the hardware processor.

11. An index selection method comprising:
a step (a) of calculating abnormality scores of a non-defective product and a defective product by using a plurality of indices based on a plurality of pieces of input data of the non-defective product and the defective product and a plurality of pieces of reference data corresponding to the input data; and
a step (b) of selecting any one of the plurality of indices according to the abnormality scores of the non-defective product and the defective product.

12. The index selection method according to claim 11, wherein the abnormality scores are differences between results of calculating the indices using the input data and results of calculating the indices using the reference data for each of the non-defective product and the defective product.

13. The index selection method according to claim 11, wherein in the step (b), an index with which a difference between a distribution of abnormality score of the non-defective product and a distribution of abnormality score of the defective product with respect to the plurality of pieces of input data and the plurality of pieces of reference data is maximized is selected.

14. The index selection method according to claim 11, further comprising a step (c) of generating reconstructed data as the reference data based on input data of a plurality of non-defective products by a generative model trained using the input data of the plurality of non-defective products.

15. The index selection method according to claim 11, wherein in the step (b), any one of the plurality of indices is selected by using a model trained so as to maximize a difference between a distribution of the abnormality score of the non-defective product and a distribution of the abnormality score of the defective product as an objective variable with feature amounts of the plurality of pieces of input data of the non-defective product and the defective product as explanatory variables.

16. The index selection method according to claim 11, wherein the input data is color image data, and in the step (b), the abnormality scores based on hues and/or saturation are calculated as the indices.

17. A non-transitory recording medium storing a computer readable index selection program for causing a computer to execute the processing included in the index selection method according to claim 11.
